(19) United States
(12) Patent Application Publication
(10) Pub. No.: US 2025/0307968 A1
(43) Pub. Date: Oct. 2, 2025

(54) INTEGRATED AUTHORIZED PUBLIC ALERT AND ARTIFICIAL INTELLIGENCE AIDED NEWS AND INFORMATION AGGREGATION, CREATION AND DISTRIBUTION SYSTEM AND METHOD FOR ITS USE

(71) Applicant: FUTURI MEDIA, LLC, Seven Hills, OH (US)

(72) Inventors: Daniel ANSTANDIG, Bay Village, OH (US); Craig BOWMAN, Durand, MI (US)

(21) Appl. No.: 19/089,798

(22) Filed: Mar. 25, 2025

Related U.S. Application Data
(60) Provisional application No. 63/570,558, filed on Mar. 27, 2024.

(51) Int. Cl. G06Q 50/26; G08B 27/00

(52) U.S. Cl. CPC G06Q 50/265; G08B 27/00

(57) ABSTRACT

An artificial Intelligence generated multilingual alerting and news creation and distribution system comprising a software and hardware system and method for their use, that act together to gather, aggregate, curate, verify, content, characterize, distribute and disseminate news content including follow-up i.e. for broadcast media distribution and wherein that system can generate and incorporate AI read news content optionally in multiple languages as a feature of the system. The invention relates to a fully integrated cloud-based broadcast system which has the ability to address and interact with external sources, including for example, Federal, State, and Local Emergency Operation Centers, including, EAS (Emergency Alert System), and IPAWS (Integrated Public Alert Warning System), as well as more local alert systems. The system is designed to provide safety protocols which include audio fingerprinting which the system uses for further authentication and verification of the audio files in an aspect of the invention.

### FIELD OF THE INVENTION

The present invention relates to an artificial Intelligence generated multilingual alerting and news creation and distribution system comprising a software and hardware system and method for their use, that act together in one or more of the following acts; to coordinate with authorities at various official levels for the purpose of characterization and dissemination of important public information and in an integrated manner to gather, aggregate, curate, verify, content, characterize, distribute and disseminate related news content such as for broadcast media distribution and wherein that system can generate and incorporate AI read news content optionally in multiple languages as a feature of the system. The system includes a robust dissemination and distribution architecture to allow for open ended communication with the public, meaning that content is selectively delivered through various sources to both appropriate governmental entities for broadcast or publication, as well as to other appropriate broadcast entities, including, for example radio, television, social media, wireless providers, road signs, local messaging systems, and wireless providers. The system has the ability to provide follow-up information, including long-form information, for example relating to the on-going nature of an event or public directions relating to the event, or to resolutions of the initial event.

### BACKGROUND OF THE INVENTION

The proliferation of modes of communication during this and the preceding century has made communication more accessible, but in some ways, also more complicated since differing groups of a population have different preferences in receiving news and other public information. Thus, while some members of a population may receive important directives through wireless services, such as weather or amber alerts, others in the same location may choose to listen to local broadcast weather, and still others may rely on TIKTOK or FACEBOOK. While alerting systems exist on the federal, state, and local level, there lacks a system to collect and receive alert type information in the aggregate from these official sources, to verify, to characterize, to prioritize, to deduplicate, to edit, to curate, to translate, so as to form alert content and to prepare appropriate voiced audio versions of the content, and further to disseminate and distribute either text or audio versions of the content back through appropriate channels in safe and secure manners to assure that the content is not corrupted or distorted from the original information. In addition, the prior art alerting systems suffer from the following common short-comings or failures addressed by the present invention: the ability to address an open audience that is not pre-defined, such as by membership or prior agreement to receive information; the ability to provide “long form” content, meaning that it is longer than two minutes in duration (such as might be necessary to explain follow-on or follow-up information, including resolution of a previous alert situation); robust and redundant messaging platforms, such as might be necessary in the event of emergency situations; the ability to rank or prioritize information and to include such characterizations in the distribution network; the ability to receive information from alternate sources and to combine and deduplicate and edit the feed into appropriate curated content; the ability to provide an integrated automated system for the creation and distribution of related news content through new and traditional media, including broadcast and on-line radio and television, and all forms of social media.

The present invention relates to a fully integrated cloud-based broadcast system which has the ability to address and interact with external sources, including for example, Federal, State, and Local Emergency Operation Centers, including, for example, EAS (Emergency Alert System), and IPAWS (Integrated Public Alert Warning System), as well as more local alert systems and social media. The system is designed to provide safety protocols which include information verification and audio fingerprinting which the system uses for further authentication and verification of the audio files in an aspect of the invention.

The system has the ability to integrate information provided by authenticated authorized information systems, to classify the integrated information as to multiple tiers of priority depending on the potential impact of the information, including the immediacy, breadth and severity of any associated risk. Following such classification, the information can be pushed to the appropriate channels for dissemination, including existing public alert systems, broadcast television, radio, the internet, cable systems, social media, wireless providers, mobile providers, redundant federal and local messaging systems, and private closed and open communication systems, such as ALEXA, ON-STAR, and local EMS and school communication networks, and traffic notifications, such as programable electronic display signs.

The system is designed with robust telecommunication in mind, including satellite internet back-up and overlapping and even redundant sourcing including for example, local, state, and federal authenticated sourcing.

Information output is disseminated according to the tier classification, and follow-up or follow-on information is provided through the appropriate corresponding channels, including through “long form” AI read audio messages (“long form” meaning herein exceeding 2 minutes in length, and including 10 second to 10 minute or 30 second to 5 minutes audio messages.). It is believed that no prior system exists for relative to coordinating and distributing public alerts and for the integration of news content related to the alert such as receiving, classifying, curating verifying, re-writing, translating, voicing, disseminating, distributing and protecting such long form alerts and follow-on information.

### SUMMARY OF THE INVENTION

The present invention includes software and hardware as a system that receives and coordinates alert information as provided by external sources. This information is pushed to the public in accordance with public directives from one or more of the following official information sources: Local Emergency Operation Centers, State Operation Centers, Federal Department of Transportation, state departments of transportation, local departments of transportation, municipalities, communities, local groups and other authorized sources of information and public directives.

The present invention also provides an automated content driven broadcast system which integrates the foregoing content in text or read form including using machine generated translations and announcer, capable of providing filtered, accurate, up-to-date, informative and directive spontaneous content for listeners. The system uses a content system to generate content and to integrate various sources of content from inside (internal) and outside (external) of the broadcast station.

The content system of the present invention further monitors multiple digital social interactions around a topic or alert for the purpose of providing real-time insight on which topics are of greater importance to a particular audience. This system further provides the apparatus and structure to collect information deemed to be a topic, to take a set of references to the topic and integrate that into a thread and to place the thread into a pulse category, to calculate the amount of interest in the thread and the growth of interest in the thread as well as the rate of change of the growth of interest and to formulate a rank of the interest which is displayed visually to a consumer by pulse topic This content is monitored for increases and decreases in interest trends and ranked to provide “pulses” of curated content to be integrated in the form of audio files along with other programming and advertising. This content is ranked and parsed according to a defined syntax pre-selected by the broadcast station.

The content is passed to a broadcast programming system which uses a log through a link, for example through the use of break notes which may be parsed and subsequently used to create audio files in the form of machine generated voice tracks. The content system uses advanced artificial intelligence algorithms, natural language processing, and speech synthesis techniques such as text to talk synthesis (“TTS”) to create high-quality, human-like voice for the voice track, and audio files incorporating the voice track then incorporate attributes selected by the broadcast station to imbue the voice track with apparent personality traits, including, for example, gender, age, speech characteristics, tonal modulation, pitch, timing, laughter, aspiration, prosody, and other audible indications of emotion or non-speech communication.

The TTS technology can use known methods to imbue the resultant audio files with a sentient or human seeming sound. These would include the use of a trained neural network or Vocoder to create speech that is comprehensible, natural and appropriate conveys emotional content. Training can be accomplished using a human trainer or a trained AI, for example, using an expressivity score based on quantitative characteristics and may or may not be used to convey features, including accent, style, register, and emotion. This speech can be based on a fundamental frequency and be represented by or displayed as a wave-form (i.e., a pitch trace), but which is provided as an audio file or machine readable code capable of functioning with hardware of a given specification. Sampling techniques can be applied as a part of the synthesis. These files can also be provided in the form of intermediate speech data, such as by means of a spectrogram, including for example, a mel spectrogram which encodes a magnitude of a complex number as a function of frequency and time, and which uses short-term Fourier transform computed over a finite frame size, such as 50 ms and a suitable window function using a non-linear transform to convert the frequency axis. Alternatively, a deep learning based speech model which could use an algorithm based conversion module can be used to convert the intermediate speech to output speech audio files.

The resultant audio may include varying intonation or greater or lesser range, based on an aligned phoneme pitch and may also incorporate prominence pitch in the establishment of global values for a speaker, where a prominence peak is a value in a high frequency band for a given phoneme. This can be a single stage as described or two stage process, for example in the latter case, in which an intonation vector is generated using a pitch track received from a second speech synthesis model for received text and using that to generate a pitch vector based on the average pitch of each phenome, and in this case varying the intonation of one or more phenomes to produce an intonation vector. Similarly, timing and intensity can be manipulated to further modify the resultant speech and implied characteristics. Thus, the resultant prosody is based on one or more of pitch, intensity, timing, formants, and harmonicity.

In addition, the present invention uses audio fingerprinting of audio files that have been generated. Audio fingerprinting is a process that generates unique digital representations of audio signals, which can be used for various applications such as content identification and subsequent authentication and verification, copyright enforcement, and audio matching in music streaming services. Robust, efficient, and accurate audio fingerprinting algorithms are essential for enabling identification or authentication of audio signals even when subjected to distortion, compression, or transmission errors. The present invention provides a system and method for generating audio fingerprints for later verification and authentication. The system comprises modules for preprocessing, feature extraction, quantization, hashing, fingerprint generation, storage, and authentication and verification. Additionally, the fingerprint can be used as an ID for individual broadcasters and to ensure levels of security and exclusivity with respect to the generated audio files.

In one aspect, the method includes preprocessing a raw audio signal, extracting key features from the preprocessed signal, quantizing the extracted features, generating a series of hashes based on the quantized features, combining the hashes to form an audio fingerprint, and storing the fingerprint in a database or using it directly for comparison with other fingerprints.

Accordingly, one aspect of the invention is an automatic content generating AI voice driven alert system, comprising:
1) a content generation module configured to:
a. receive inputs from various data sources selected from the group comprising IPAWS and local groups, community alerts from municipalities, federal state and local departments of transportation, state and local emergency communication centers, and proprietary sources to gather information in accordance with user generated instruction alert content;
b. process the inputs using natural language processing techniques to extract relevant information, analyze sentiment, identify and classify alert information;
c. generate contextually appropriate content, from the alert information through various manipulations, including for example, verification, deduplification, curation, editing, characterization and classification and translation;
2) a speech synthesis module configured to:
a. act according to user selected parameters to choose language characteristics, including the selected language and regional choices, the register and emotional content for an AI generated audio file based on the content,
b. where appropriate to convert the Machine generated content into human-like speech as an audio file using advanced text-to-speech algorithms, customizable to different voice types, gender, age, pitch, emotional content, speech patterns, accents, languages based on the generated content and in accordance with user generated instructions;
c. apply audio processing techniques to optimize the generated speech for broadcasting, including volume normalization, equalization, and dynamic range compression;
d. a fingerprint and authenticate and verify the audio file;
3) a distribution and control module configured to:
a. provide for closed and/or open public dissemination of any generated content, including any audio file, which dissemination includes dissemination to, existing public alert systems; radio, television and internet broadcasting; cable systems; mobile alerts; social media; and programmable road and traffic signs.
b. manage the timing and sequencing of the dissemination and re-publishing or up-date of the generated content based on predefined rules;
c. monitor the performance of the system and adapt the content generation and speech synthesis processes based on ongoing learning; and
4) a user interface module configured to provide user input and system instruction, including an over-ride control as a fail-safe and to provide for follow-up information.:

The foregoing and other aspects, features, and advantages of the invention will be apparent from the following detailed description of the invention.

### BRIEF DESCRIPTION OF THE DRAWINGS

FIG. 1 is a block diagram of one component of the invention;

FIG. 2 is a schematic of the information collection and dissemination component of the system; and

FIG. 3 is a schematic of the information processing component of the invention;

### DETAILED DESCRIPTION OF THE INVENTION

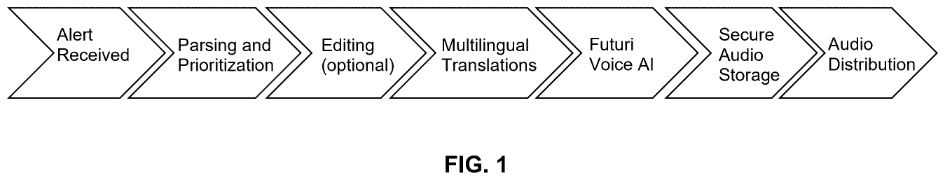

FIG. 1 shows a block diagram of the present invention illustrating the various modules that provide for user directed automated generation of content. This generated content is subsequently subjected to manipulation by a voice synthesis module (which uses AI, or Artificial Intelligence, also referred to herein as “machine generated”) which uses sophisticated analytics to determine an emotional content, and which subsequently creates an audio file based applying selected voice attributes to create one of more audio files. The audio files are then passed to a fingerprinting component and held until a control module directs the system to pass the audio file to distribution, including, for example to an up-date feature or to play in a broadcast situation. This is presented within the context of the interaction between the external stream source, i.e., the broadcast station or broadcast automation system and the content provider feed stream or broadcast automation system. While the invention can be implemented in a system which is implemented and managed apart from the broadcast station, it should be understood that the feed stream and production system source can be internal to the broadcast station and operate as part of the automation system and where a link of the present invention is used as a platform or mechanism to import either files external to the, file system, and/or automation system or to determine content to be placed into a file or location in existence in the automation system playlist or selection sequence. File storage and communication is secure and may take place behind with appropriate secure measures including, for example, fire-wall and/or encryption protocol, and the technology disclosed may also provide for library services with respect to the initial content and for the edited version as well. As mentioned-above, example mechanisms for accomplishing this include HTTP Live Streaming (HLS) style manipulation, but used for audio or audio and video, in which HTTP file transfer technology is used to transfer the feed segments to the cloud or other secure remote or in-house file locations. HLS is an HTTP-based media streaming communications protocol that works by breaking the overall stream into a sequence of small HTTP-based file downloads, each download loading one short chunk of an overall potentially unbounded transport stream.

As an illustration, the various components of the invention may include the following:
1) a content generation module configured to receive inputs from various data sources, including but not limited to IPAWS and IPAWS sources; process the inputs using natural language processing techniques to extract relevant information, analyze sentiment, and identify and classify trending information or informational topics into one or more, and preferably 3-5 tiers of categories based on the need to notify the public of the information, and thereby to generate contextually appropriate content for public alert notification; 2) a speech synthesis module configured to: convert the Machine generated content into human-like speech as an audio file using advanced text-to-speech algorithms, customizable to different voice types, gender, age, pitch, emotional content, speech patterns, accents, languages based on the generated content; apply audio processing techniques to optimize the generated speech for alert broadcasting, including but not limited to, volume normalization, equalization, and dynamic range compression; and a fingerprint and authenticate and verify the audio file; 3) a control module configured to integrate a text or audio file of the generated content into existing alert systems; to manage the timing and sequencing of the generated content based on predefined rules, real-time authenticated governmental directives, and other relevant factors; monitor the performance of the system and adapt the content generation and speech synthesis processes based on feedback, listener preferences, and ongoing learning; and 4) a user interface module configured to allow official operators to customize the system's parameters including relating to the generated audio files, including but not limited to, voice settings, content preferences, and integration settings; and provide real-time monitoring and control capabilities for the system, including but not limited to, content filtering, preview and optional iterative production content production capability, manual override, and performance metrics.

By way of non-limiting example, various components are described and shown, which may perform various functions and interact with each other. These components may be segregated based on their function merely for the sake of description and may represent computer hardware and executable software code which may be stored on a computer-readable storage medium for execution on appropriate computing hardware or mobile devices. The various functions of the different components may be combined or segregated as hardware or software stored on a computer-readable medium in any manner, and may be used separately or in combination.

The present invention provides a system for creating and providing material in the form of text and/or audio based upon content captured or provided from externally based feed sources. The raw input is processed, such as by parsing, analyzing, indexing, comparing, filtering, curating, combining, storing, editing, accessing, and manipulating portions or all of the input. The processed data is subjected to a set of user determined rules along with selected voice attributes including for example, attributes that signal age, gender, register, emotion, pitch, phrasing, modulation, prosody, and other audio cues including laughter, breath, speech impediments, accents. The system further allows for translation into selected languages including specifying regional preferences in choice of language and grammar. This results in the production of the machine generated voice audio files for further incorporation as “hosts” or presenter AI voices into the disseminated feed resulting from the use of the present invention. Metadata marks the stream, which allows for indexing, identification, filtering and selective addition or elimination from newly created content. This feature allows an automated combination and transmission or distribution of content that ensures appropriate distribution, for example avoiding vulgarity, incendiary content or content that could cause public disorder, including for example, civil unrest, traffic issues or over-crowding on public transportation.

In addition to gathering pushed information provided by governmental and quasi-governmental authorities, the present invention can also use AI-driven localized content selection, combining GPT-3 or 4 technology with AI-driven targeted discovery and social content system to augment or enrich the information provided through official sources. In this case, information, verification can be included using AI and known secure means to verify the truth and accuracy of the AI gathered information.

By way of example, implementation of the components of the present system can initially be accessed through a dashboard available to a front-end user or station administrator, which or who enters criteria to control variables within the production process. In this implementation, a cloud-based production system is linked through the internet to a feed stream and receives an encoded feed stream which can be marked and thereby parsed for later use. The production system may be configured to act on the marked segmented feed stream by indexing, and transcribing the feed segments and by dividing the feed stream into channels as appropriate and which are linked back to the station administrator for example, for preview or approval of a generated audio file.

An analytic system may also be linked to the content production or distribution system. The analytic system may control or account for the content insertion. This can occur automatically, according to pre-arranged instructions, or immediately prior to broadcast with the help of human intervention. The analytic system may include a fingerprinting component for the identification of generated audio files. Subsequently, a filter may be applied according to user selection rules to determine if the dynamic content is cleared for use, and if so, where it may be distributed since it is possible to be cleared for some, but not all distribution channels. The clearance component may be similar to the copyright clearance inventions as known in the prior art.

The production component may be linked to a distribution system as shown in the FIGS., and which is directed by the station administrator as to where to distribute the secondary production (i.e. the material represented by the selected marked segments and added additional material including the visual material, advertising material, and metadata). The distribution system directs the secondary production to locations which can be accessed by the ultimate audience member on a mobile, lap-top or desk-top or other dedicated device, i.e., through a broad-cast station web-site, pod-cast, or through social media services. In certain aspects of the technology disclosed, the front-end may cause content to be served from the cloud-based production system directly for consumption by listener via broadcast media, including specifically broadcast radio, social media or through the internet. The filter may happen at the back-end of the production system as well.

The invention may include a streaming transmitter system that interfaces with a broadcast automation system by a middleware system and for use with the systems described and comprises an input that receives analog audio and AOPIP through Livewire and NOW PLAYING information, which includes UDP, such as raw text and XML, and TCP, such as raw text and XML. This input may be segregated into component feed streams or channels for identification and use at a later point.

A dashboard can be used to allow an authorized administrator to make changes, including for example, host attributes or content source selection. The “administrator” is a set of instructions or person who is up-stream of the feed clip collection and production process and has the ability to take control of this process, whereas a “user”, and in particular an “end-user” may also be an audience member, i.e., an entity or person downstream, who may participate in the social web-site or media based communications or to whom the results of the inventive process (i.e. the pod-cast or on-demand segment) is supplied on a device. The administrator has the ability to select a voice from a library of voices or to create a personality, including the use of an authorized human voice. The back-end further can direct the voice function to perform a script, can track generated voice tracks, for example, in a voice track que. The voice library administrate determines the voice and enters a name for the voice to be used for audio alerts, which then becomes the label for the voice in the system of the present invention. For example, the control panel can be used to select host characteristics, voice attributes, emotional status, of one or more selected machine generated personalities based on age, gender, nationality, language, emotional tendencies, or other selected registerable attributes.

Once content has been curated to form a text or script, the user may select literal read or artful read which allows for the interpretation of the script, for example with additional selectable qualities, such as stability, clarity, speed and pitch The web-based admin control panel also includes options to override the automatic production where an administrative user may edit, combine or merge or un-merge certain items out of a template production including directions to a filter component. The invention also includes a production system which is hardware having machine readable code and the code, or software system, which preferably resides in the cloud but which interfaces with the capture system by means of the internet.

The content is received in the production system where it is reviewed, associated with the metadata or “fingerprint” or wave form identifier which can be used for evaluation as to whether the content meets selection criteria or whether it needs to be subject to be screened for elimination of de-selected material, such as might be problematic due to copyright or other concerns.

This system also performs selective review of content to filter or eliminate material which is defined as sensitive material. The nature of what sensitive material is can be automatically determined by the system through the application of the filtering system of the present invention and in accordance with a set of administrator instructions. These instructions may be used to filter material which is subject to copyright and not authorized for further use, to eliminate libelous, triggering or inflammatory subject matter or material. Thus, the invention reduces the possibility of copyright infringement or other potential legal infractions, such as invasion of privacy or violation of libel or slander or requirements for truth in publication, or to produce material which meets certain parental criteria, or avoids sensitive issues.

Additionally, it will be understood that the various embodiments described herein may be implemented with data processing systems, which have more or fewer components than the illustrated system. For example, such data processing systems may include a cellular telephone or a personal digital assistant (PDA) or an entertainment system or a media player or a consumer electronic device, each of which can be used to implement one or more of the embodiments of the invention. The algorithms and displays presented herein are not inherently related to any particular computing system or other apparatus. Various general purpose systems may be used with programs in accordance with the teachings herein, or it may prove convenient to construct custom apparatuses to perform the method operations. In addition, a variety of programming languages, structure and techniques may be used to implement the teachings of the invention as described herein.

Some portions of the detailed description as set forth above are presented in terms of algorithms and symbolic representations of operations on data bits within a computer memory. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. Further, it is understood that components of the invention may be subject to AI or machine learning, which allows the system to self-educate and improve the efficiency of various components of the system, including the analytic and clearance component, as well as the integrated distribution component.

It should be understood that throughout the description, discussions utilizing terms such as “parsing”, “encoding”, “decoding”, “filing”, “transmitting” “distributing”, “storing”, “filing”, “archiving”, “scanning” or “filtering” or “calculating” or “collecting” or “tabulating” or “categorizing” or “displaying”, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices and which enables the further use, such as by visual display.

The invention may include various operations as set forth above or more or fewer operations in an order, which is different from the order described herein so long as the end purpose can be attained. The described operations may be provided in machine-executable instructions, which cause a general-purpose or special-purpose processor to perform certain tasks. Alternatively, these operations may be performed by hardware components that contain hardwired logic for performing the operations, or by any combination of programmed computer components and custom hardware components.

Thus, the software system of the present invention system includes software that provides an automation system to interact via an external communication means such as the web, with a separate server or servers which hosts the process of reception of the transmission of the alert information including processing, characterizing, prioritizing, curating, filing and storage of the alert information Specifically, the software monitors a definable location for alert or production information, such as new log exports, which are generated by the content generation module of the system. In aspects of the technology disclosed, a distribution system linked via an IP network to the production system may be used. In certain aspects, the distribution system may be configured to distribute a created alert or information content in accordance with a set of user enabled instructions, “user enabled distribution instructions”, whereby the secondary production is available for to push to, or for download by or publication on a specific device or to be streamed to a user device.

The software system of the present invention uses a surrogate or placeholder based on admin directed instructions for an AI audio file generated in accordance with the present invention. The file is a text-based file for example, which uses row and comma format for data such as is known in the broadcast industry. The invention subsequently copies the audio file contents into this placeholder file to cause that selection to be incorporated into the template for the creation of the secondary production file.

The software production system of the present invention includes components, each responsible for a separate process, that can be combined together in the system of the present invention. A component of the system may include a web-based API for example as follows: The template instructions are exported to a text file on the file system. The software link system, while monitoring for new log export files, discovers the new export file and reads it from the file system and sends a log export file to a broadcast station automation system API via the HTTP interface. The connection is left open so that the broadcast automation system server can send information back, read the template commands from the export file, and replaces the necessary commands with placeholder files, which the software link will later change with the feed clips. The updated export file (with new placeholders) is sent back to the software link system 10 application through the still-open HTTP connection, which then closes the connection.

The system of the present invention includes analytics meaning the ability to tailor the criteria for the production process as to the audience make-up or complexion, demographic, geolocation and participation value, as well as content based considerations, such as flow and provider identity. It also provides security measures to maximize both the data security of the internal automation system of the provider and the flow of information via the social media to the audience members.

The analytics referred to above are part of a fingerprinting and authentication/verification component of the system. The analytics can act to filter the dynamic content through an analysis of the meta-data, the transcription, and the fingerprint of the audio. Digital fingerprints are compact digital representations of a media content item (or a segment of a media content item) extracted from a media content item (audio or video) which represent characteristics or features of the media content item with enough specificity to uniquely identify the media content item. Original media content items (e.g., known works) may be registered to the identification service, which may include generating a plurality of segments of the original media content item. Digital fingerprints may then be generated for each of the plurality of segments. Digital fingerprints can be compared and used to identify media content items even in cases of content modification, alteration, or obfuscation (e.g., compression, aspect ratio changes, re-sampling, change in color, dimensions, format, bitrates, equalization) or content degradation (e.g., distortion due to conversion, loss in quality, blurring, cropping, addition of background noise, etc.) in embodiments. Additionally, or alternatively, digital fingerprints may be usable to verify media content items.

In accordance with the invention and shown in FIG. 1, alert information or a media content item may be received by a processing device. A set of features of the unidentified media content item may be determined. This alert information is subjected to defined processing parameters, including, for example, parsing and prioritization. An optional editing step may occur and the resultant alert is passed to multilingual translations. Artificial Intelligence is used to create a voice read version of the alert, which is subsequently stored securely in audio storage, and at used defined times and to user defined outputs, the alert is distributed as an audio file (or as a file which is capable of conversion at a receiver location of being converted to an AI generated voice read audio file.

Metadata associated with the unidentified media content item may be determined. A first similarity between the metadata associated with the unidentified media content item and additional metadata associated with a known media content item from a media content repository may be determined. A second similarity between the set of features of the unidentified media content item and an additional set of features associated with the known media content item may be determined. The unidentified media content item may be identified as a duplication based on the first similarity and the second similarity by the processing device.

The media content identification service may determine features for the unidentified media content item. The media content identification service may determine metadata associated with the unidentified media content item. The media content identification service may determine a first similarity between the metadata of the unidentified media content item and additional metadata associated with a known media content item of a plurality of media content items from a media content repository. The media content identification service may determine a second similarity between the determined set of features of the unidentified media content item and an additional set of features association with the known media content item. The media content identification service may identify the unidentified media content item as a cover of the known media content item based upon the first similarity of the metadata and the second similarity of the set of features.

The media content identification service may further update the metadata of the unidentified media content item to include cover information that identifies the unidentified media content item as a cover of the known media content item. The metadata within the unidentified media content item may include a metadata description attribute that describes the unidentified media content item.

The media content identification service may, when determining the first similarity between the metadata associated with the unidentified media content item and the additional metadata associated with the known media content item, normalize the metadata of the unidentified media content item to generate a normalized descriptive text for the unidentified media content item. The media content identification service may compare the normalized descriptive text of the unidentified media content item with normalized descriptive text of the known media content item. The normalized descriptive text of the known media content item may be based on the additional metadata associated with the known media content item. The media content identification service may generate a similarity score between the normalized descriptive text of the unidentified media content item and the normalized descriptive text of the known media content item. The media content identification service may determine that the similarity score is above a similarity threshold.

In certain aspects, the technology disclosed describes a production and/or creation system for creating and providing broadcast content which incorporates an audio file created using an AI speech generated component. The production creation system includes a content generation component that can be based on user indicated timing to read a literal script or to interpret and incorporate external content. The production creation system is linked through the internet to receive a log and log instructions and to find and incorporate additional material as directed so as to create generated content, which is used to create an audio file using a customized machine generated personality where the audio file is provided to a presentation device (e.g., a station automation system) of a broadcast station. In addition, the audio file is further subjected to fingerprinting by the production system which is used for verification and authentication of that alert information for security and to provide proprietary rights to individual users (such as to ensure that individual audio files are not identical in content and personality profile in contradiction to user contractual rights and transmitting the fingerprinted audio file to a distribution system; and a distribution system comprising a machine with machine readable code which is linked, e.g. via an IP network such as the internet, to the production system and which is configured to distribute the audio files as indicated.

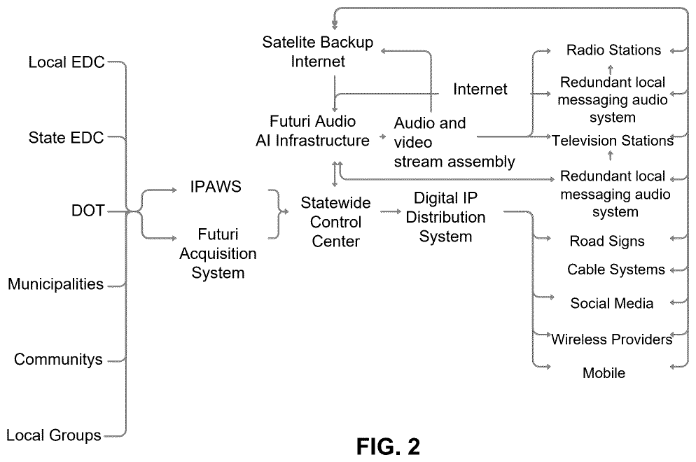

FIG. 2 illustrates the invention in which alert information is gathered from exemplary sources, including local EDC, state EDC, DOT, municipalities, communities, and local groups. This alert information is feed both to IPAWS and to the present alert acquisition system. The alert information is passed to statewide control center from both of IPAWS and from the present system. The statewide control centers push the information through existing internet protocol (IP) distribution systems and from there to known publication platforms, including road signs, cable systems, social media, wireless providers and mobile providers to name examples. The alert information is also passed from to an AI audio infrastructure in accordance with the present invention where it passes to audio and video stream assembly subsystems, as well as to satellite back-up internet and to broadcast systems including redundant local messaging audio systems, television stations, and radio stations.

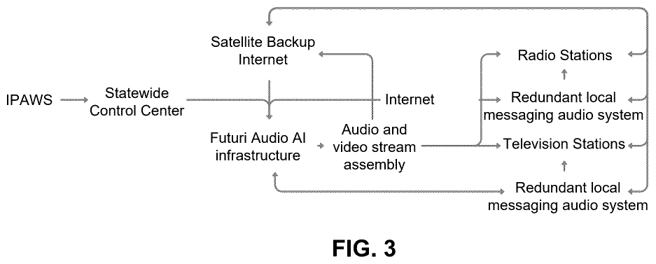

FIG. 3 illustrates a production component of the present invention in which IPAWS information is passed to statewide control center, and from there directly by means of the internet to radio stations, to redundant local audio messaging systems, and to television stations. The alert information is passed from the audio AI infrastructure of the present invention to audio and video stream assembly through satellite back-up internet as a safety precaution.

While in accordance with the patent statutes the best mode and preferred embodiment have been set forth, the scope of the invention is not limited thereto, but rather by the scope of the attached claims.

What is claimed is:

1. A public alert and integrated news creation and distribution system, comprising:
a software and hardware system, that act together in one or more of the following acts; to coordinate with official authorities at one or more of the federal, state, and local governmental level to characterize and disseminate of information and in an integrated manner to do one or more of gathering, aggregating, curating, verifying, content, characterization of content, distribution of content and dissemination of news content for broadcast media distribution, and wherein that system can is capable of generating and incorporating AI read news content.

2. The public alert and integrated news creation and distribution system of claim 1, further including a dissemination and distribution architecture to allow for open ended communication with the public.

3. The public alert and integrated news creation and distribution system of claim 1, wherein the content is selectively delivered for publication through a plurality of sources to both governmental entities and other broadcast entities.

4. The public alert and integrated news creation and distribution system of claim 3, wherein the sources include one or more of radio, television, social media, wireless providers, road signs, local messaging systems, and wireless providers.

5. The public alert and integrated news creation and distribution system of claim 4, wherein the system further provides follow-up information to one or more source previously used.

6. The public alert and integrated news creation and distribution system of claim 5, wherein the follow-up information is long-form information.

7. The public alert and integrated news creation and distribution system of claim 6, wherein the follow-up information relates to the on-going nature of an event.

8. The public alert and integrated news creation and distribution system of claim 6, wherein the follow-up information relates to public directions relating to the event.

9. The public alert and integrated news creation and distribution system of claim 6, wherein the follow-up information relates to resolution of an event which was the subject of an alert.

10. The public alert and integrated news creation and distribution system of claim 1, wherein the alert and news are read by an AI generated voice.

11. The public alert and integrated news creation and distribution system of claim 10, wherein the new is provided in more than one language.

12. An automatic content generating AI voice driven alert system, comprising:
1. a content generation module configured to:
a. receive inputs from various data sources selected from the group comprising IPAWS and local groups, community alerts from municipalities, federal state and local departments of transportation, state and local emergency communication centers, and proprietary sources to gather information in accordance with user generated instruction alert content;
b. process the inputs using natural language processing techniques to extract relevant information, analyze sentiment, identify and classify alert information;
c. generate contextually appropriate content, from the alert information through various manipulations, including one or more of verification, deduplification, curation, editing, characterization and classification and translation;
2. a speech synthesis module configured to:
a. act according to user selected parameters to choose language characteristics, including the selected language and regional choices, the register and emotional content for an AI generated audio file based on the content,
b. where appropriate to convert the Machine generated content into human-like speech as an audio file using advanced text-to-speech algorithms, customizable to different voice types, gender, age, pitch, emotional content, speech patterns, accents, languages based on the generated content and in accordance with user generated instructions;
c. apply audio processing techniques to optimize the generated speech for broadcasting, including volume normalization, equalization, and dynamic range compression;
d. a fingerprint and authenticate and verify the audio file;
3. a distribution and control module configured to:
a. provide for closed and/or open public dissemination of any generated content, including any audio file, which dissemination includes dissemination to, existing public alert systems; radio, television and internet broadcasting; cable systems; mobile alerts; social media; and programmable road and traffic signs.
b. manage the timing and sequencing of the dissemination and re-publishing or up-date of the generated content based on predefined rules;
c. monitor the performance of the system and adapt the content generation and speech synthesis processes based on ongoing learning; and
4. a user interface module configured to provide user input and system instruction, including an over-ride control as a fail-safe and to provide for follow-up information.
